(19) United States
(12) Patent Application Publication
(10) Pub. No.: US 2025/0018813 A1
(43) Pub. Date: Jan. 16, 2025

(54) AUTOMATED ELECTRIC VEHICLE CHARGING SYSTEMS AND ASSOCIATED METHODS

(71) Applicant: BP Exploration Operating Company Limited, Middlesex (GB)

(72) Inventors: Thais Moraes LAUER, Esher (GB); Noman Nadeem RANA, Slough (GB); Abigail Yuh Shyuan LEE, London (GB); Udit SRIVASTAV, London (GB); Raihan NOUSHAD, London (GB); Romeo ORSOLINO, London (GB); Stefan LIPPITSCH, Graz (AT); Thomas SEEBACHER, Graz (AT); Mario HIRZ, Graz (AT)

(73) Assignee: BP Exploration Operating Company Limited, Middlesex (GB)

(21) Appl. No.: 18/771,069

(22) Filed: Jul. 12, 2024

(30) Foreign Application Priority Data
Jul. 12, 2023 (GB) 2310713.9

(51) Int. Cl. B60L 53/37; H01R 13/629; H02J 7/00

(52) U.S. Cl. CPC B60L 53/37; H02J 7/0042; H01R 13/629

(57) ABSTRACT

An end effector for an automated electric vehicle charging system includes a chassis including a chassis connector for coupling the end effector to an end of a robotic arm; and a support rail unit coupled to the chassis and including an elongate support rail, a carriage slidably coupled to the support rail and including a carriage connector configured to couple to an electric distributor charging connector of the electric vehicle charging system, and a carriage actuator coupled between the support rail and the carriage for transporting the carriage along the support rail.

### CROSS-REFERENCE TO RELATED APPLICATIONS

This application claims priority to United Kingdom Patent Application No. 2310713.9 filed Jul. 12, 2023, entitled “Automated Electric Vehicle Charging Systems and Associated Methods”, which is incorporated herein by reference in its entirety.

### STATEMENT REGARDING FEDERALLY SPONSORED RESEARCH OR DEVELOPMENT

Not applicable.

### BACKGROUND

Electric vehicles (EVs) are vehicles that include one or more electric motors for propelling the EV to its given destination. For example, EVs may be in the form of commercial vehicles (e.g., electric trucks such as electric tractor-trailers) or passenger vehicles. Generally, the one or more electric motors of an EV are powered by an onboard electric battery such as, for example, lithium-ion batteries supported on a chassis of the EV and electrically connected to the one or more electric motors also supported on the chassis or mounted in the wheels. Typically, EV batteries are rechargeable such that the energy stored in the battery may be periodically replenished or recharged as the energy of the battery is consumed by the one or more electric motors of the EV during operation. For example, EV batteries may be recharged by a charging station or charge point permitting an operator of an EV to manually connect the batteries of their EV to a charger of the charging station whereby electrical power may be delivered from the charging station to the batteries of the EV.

### SUMMARY

An embodiment of an end effector for an automated EV charging system comprising a chassis comprising a chassis connector for coupling the end effector to an end of a robotic arm, and a support rail unit coupled to the chassis and comprising an elongate support rail, a carriage slidably coupled to the support rail and comprising a carriage connector configured to couple to an electric distributor charging connector of the EV charging system, and a carriage actuator coupled between the support rail and the carriage for transporting the carriage along the support rail. In some embodiments, the carriage is configured to transport the distributor charging connector along a linear charger transport axis in response to the activation of the carriage actuator when the distributor charging connector is coupled to the carriage. In some embodiments, the end effector comprises a gripper unit coupled to the chassis and configured to open an external cover of the EV enclosing a vehicle charging connector of the EV. In certain embodiments, the gripper unit comprises a suction gripper and a suction unit each coupled to the chassis, wherein the suction unit is configured to apply a vacuum to a suction chamber defined by the suction gripper to releasably couple the suction gripper to the external cover. In certain embodiments, the gripper unit further comprises a gripper actuator configured to displace the suction gripper relative to the chassis along a gripper axis. In some embodiments, the end effector comprises a controller communicatively coupled to the carriage actuator, and a sensor unit coupled to the chassis and configured to provide the controller with sensor data as the controller controls the operation of the carriage actuator. In some embodiments, the sensor unit comprises a camera having a field of view projecting from a front of the end effector. In certain embodiments, the end effector comprises a plug handler unit coupled to the chassis, the plug handler unit comprising an actuatable plug handler for gripping an internal plug of a vehicle charging connector of an EV. In certain embodiments, the plug handler comprises a gripper actuator and a pair of grippers coupled to the gripper actuator, the gripper actuator configured to displace the pair of grippers to increase and decrease a width of an opening formed between the pair of grippers. In some embodiments, the plug handler unit comprises a handler actuator configured to pivot the plug handler relative to the support rail unit between a standby position and an operating position spaced from the standby position.

An automated EV charging system comprises a power distributor for distributing electrical power to one or more EVs, an electric distributor charging connector connected to the power distributor by an electrical cable, a robotic arm extending between a proximal end and a distal end opposite the proximal end, the robotic arm comprising one or more actuatable joints, an end effector coupled to the distal end of the robotic arm, wherein the distributor charging connector is coupled to and carried by the end effector, and a controller communicatively coupled to the robotic arm and the end effector, the controller configured to manipulate the robotic arm and the end effector to electrically connect the distributor charging connector to a vehicle charging connector of an EV whereby electrical power is transmittable from the power distributor to the EV. In some embodiments, the end effector comprises a chassis comprising a chassis connector coupled to the distal end of the robotic arm, and a support rail unit coupled to the chassis an comprising an elongate support rail, a carriage slidably coupled to the support rail and comprising a carriage connector configured to couple to an electric distributor charging connector of the EV charging system, and a carriage actuator coupled between the support rail and the carriage for transporting the carriage along the support rail. In certain embodiments, the controller is communicatively coupled to the carriage actuator and configured to operate the carriage actuator to transport the distributor charging connector along a linear charger transport axis to establish an electrical connection between the distributor charging connector and the vehicle charging connector. In certain embodiments, the end effector comprises a chassis and a gripper unit coupled to the chassis, the gripper unit comprising a suction gripper operable by the controller to open an external cover of the EV enclosing the vehicle charging connector. In some embodiments, the end effector comprises a sensor unit communicatively coupled to the controller, the sensor unit comprising a camera configured to provide the controller with image data captured by the camera. In some embodiments, the end effector comprises a chassis and a plug handler unit coupled to the chassis, the plug handler unit comprising an actuatable plug handler operable by the controller for gripping an internal plug of a vehicle charging connector of an EV. In certain embodiments, the plug handler unit comprises a handler actuator communicatively coupled to the controller, the controller configured to operate the handler actuator to pivot the plug handler between a standby position and an operating position spaced from the standby position.

An embodiment of a method for charging an EV using an automated EV charging system comprises (a) manipulating an end effector of the EV charging system that is coupled to a robotic arm of the EV charging system to open an external cover of an EV enclosing a vehicle charging connector of the EV, (b) manipulating the end effector to electrically connect a distributor charging connector of the EV charging system to the vehicle charging connector to transmit electrical power from a power distributor of the EV charging system to the EV, and (c) manipulating the end effector to close the external cover of the EV to enclose the vehicle charging connector. In certain embodiments, (a) comprises (a1) manipulating a suction gripper of the end effector to form a releasable connection between the suction gripper and the external cover, and (a2) manipulating the suction gripper to release the connection formed between the suction gripper and the external cover once the external cover has been opened by the end effector. In some embodiments, (b) comprises (b1) manipulating the end effector to transport the distributor charging connector in a first direction along a charger transport axis to electrically connect the distributor charging connector to the vehicle charging connector, and (b2) manipulating the end effector to transport the distributor charging connector in a second direction, opposite the first direction, along the charger transport axis to electrically disconnect the distributor charging connector from the vehicle charging connector.

### BRIEF DESCRIPTION OF THE DRAWINGS

For a detailed description of various exemplary embodiments, reference will now be made to the accompanying drawings in which:

FIG. 1 is a perspective view of an embodiment of an automated EV charging system according to principles disclosed herein;

FIG. 2 is a perspective view of embodiments of a robotic arm and an end effector according to principles disclosed herein;

FIG. 3 is a perspective view of the end effector of FIG. 2;

FIG. 4 is a side view of the end effector of FIG. 2;

FIG. 5 is a perspective view of another embodiment of an end effector according to principles disclosed herein;

FIG. 6 is a side view of the end effector of FIG. 5; and

FIGS. 7 and 8 are perspective view of an embodiment of a pair of plug handlers of the end effector of FIG. 5 in accordance with principles disclosed herein.

### DETAILED DESCRIPTION

The following discussion is directed to various exemplary embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in interest of clarity and conciseness.

In the following discussion and in the claims, the terms “including” and “comprising” are used in an open-ended fashion, and thus should be interpreted to mean “including, but not limited to . . . ” Also, the term “couple” or “couples” is intended to mean either an indirect or direct connection. Thus, if a first device couples to a second device, that connection may be through a direct connection of the two devices, or through an indirect connection that is established via other devices, components, nodes, and connections. In addition, as used herein, the terms “axial” and “axially” generally mean along or parallel to a particular axis (e.g., central axis of a body or a port), while the terms “radial” and “radially” generally mean perpendicular to a particular axis. For instance, an axial distance refers to a distance measured along or parallel to the axis, and a radial distance means a distance measured perpendicular to the axis. As used herein, the terms “approximately,” “about,” “substantially,” and the like mean within 10% (i.e., plus or minus 10%) of the recited value. Thus, for example, a recited angle of “about 80 degrees” refers to an angle ranging from 72 degrees to 88 degrees.

As described above, operators of EVs may periodically visit EV charging stations whereby the operator may connect a charger of the charging station to deliver electrical power to the batteries of the operator's EV. In at least some instances, the electrical power supplied to the batteries of the EV is derived from an alternating current (AC) electrical grid which may be converted to direct current (DC) prior to being supplied to the EV.

Conventionally, EV charging stations include one or more column-shaped power distributors each connected to one or more flexible electrical cables. The power distributor receives electrical power from a power source, such as an electrical grid, and may condition the electrical power received from the power source such that the electrical power deliverable by the power distributor meets the specifications of one or more EVs. For example, the power distributor may include an AC-DC power converter for converting AC received from the power source to DC to be delivered to the batteries of the EVs charged by the charging station. Additionally, the one or more electrical cables connected to a respective power distributor of an EV charging station has an electrical distributor charging connector (e.g., an electrical plug or socket) located at a terminal end of the respective electrical cable.

Generally, an operator of an EV seeking to recharge the batteries of their EV may park their EV adjacent to one of the power distributors of a given EV charging station. The driver may then exit their vehicle, and manually grasp one of the distributors charging connectors coupled to the power distributor. Having the distributor charging connector in hand, the operator may manually remove any external covers or plugs enclosing a corresponding vehicle charging connector of their EV (e.g., an electrical charging connector positioned in a recess along a body of the EV) that is connected to the battery of the EV. After exposing the vehicle charging connector, the operator may manually physically connect the distributor charging connector of the power distributor to the vehicle charging connector to thereby form an electrical connection between the battery of the EV and the power distributor. It may also be understood that the operator may also initiate a transaction for a desired quantity of electrical power to be supplied to the operator's EV before or after plugging the EV into the power distributor. For example, the operator may utilize an interface (e.g., a touchscreen) of the power distributor to initiate the transaction. Alternatively, the operator may initiate the transaction through an application executing on a personal computing device (e.g., a smartphone of the operator) and associated with a provider or operator of the respective EV charging station.

It may be understood that the process of exiting the vehicle, manually grasping the distributor charging connector connected to the power distributor, manually removing any covers or plugs enclosing the vehicle charging connector of the operator's EV, and manually connecting the distributor charging connector to the vehicle charging connector may, along with the inconvenience incurred in manually executing these tasks, increase the total time required for recharging the battery of the EV at the charging station, particularly in view of high performance power distributors now being deployed commercially, which are capable of recharging the batteries of an EV in only a few minutes. Additionally, the requirement of the operator of manually electrically connecting their EV to a power distributor of an EV charging station poses additional safety risks to the operator and others due to, for example, error on the par of the operator when handling the equipment of the charging station, and/or malfunctioning equipment of the charging station. Further, some operators may not have the mobility, strength, balance, and/or dexterity required to manually connect their EV to a power distributor of a conventional EV charging station, unfairly restricting their access to such critical infrastructure.

Accordingly, embodiments of automated EV charging systems are disclosed herein which address the issues highlighted above associated with conventional EV charging stations. Particularly, embodiments of automated EV charging systems disclosed herein include a robotic arm carrying an end effector each controllable by a controller of the EV charging system for facilitating the charging of one or more EVs without the need for manual intervention. Embodiments of end effectors described herein include a rail support unit including an elongate support rail and a carriage slidably coupled to the support rail, the carriage connectable to a distributor charging connector of the EV charging system such that the distributor charging connector may, as controlled by the controller, be transported along the support rail of the end effector. Additionally, in some embodiments, end effectors described herein additionally include a gripper unit for, as controlled by the controller, opening an external cover of an EV enclosing a vehicle charging connector of the EV such that the end effector may obtain access to the vehicle charging connector. Further, in some embodiments, end effectors described herein include a plug handler unit for, as controlled by the controller, removing one or more internal plugs of the EV protecting one or more corresponding vehicle charging connectors of the EV.

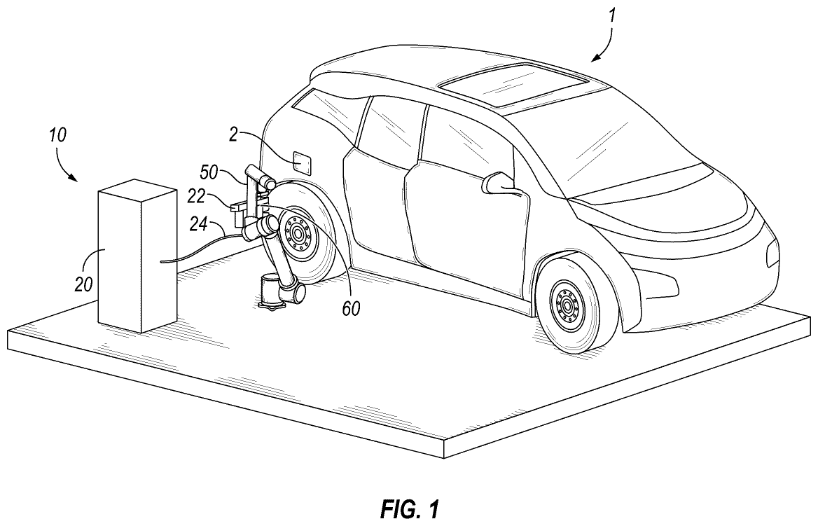

Referring now to FIG. 1, an embodiment of an automated EV charging system 10 is shown for electrically recharging a battery (not shown in FIG. 1) of an EV 1. In this exemplary embodiment, EV charging system 10 generally includes an electrical power distributor 20, a robotic arm 50, and an end effector 60. The power distributor 20 of EV charging system 10 is electrically connected to an electrical power source (not shown in FIG. 1) from which electrical power may be delivered by the EV charging system 10 to the battery of EV 1. For example, the power distributor 20 may include, among other equipment, an AC-DC power converter for converting AC received by the power distributor 20 from the power source to DC usable by the battery of EV 1.

In this exemplary embodiment, the EV charging system 10 additionally includes an electrical distributor charging connector 22 connected to the power distributor 20 by a flexible electrical cable 24 extending and coupled therebetween. As will be discussed further herein, the distributor charging connector 22 is carried by the end effector 60 of EV charging system 10 to perform an electrical charging operation of the battery of EV 1 without assistance from an operator of EV 1. In this manner, an operator of the vehicle 1 need not exit their vehicle 1 in order to have the battery thereof charge by the EV charging system 10. Instead, if desired, the operator of vehicle 1 need only drive the vehicle 1 such that it is positioned in proximity of the EV charging system 10 (e.g., within physical reach of the distributor charging connector 22 of EV charging system 10) as depicted in FIG. 1. Once positioned in proximity of the EV charging system 10, the EV charging system 10 may automatically charge the battery of the vehicle 1 once the operator of vehicle 1 (or another user of EV charging system 10) has initiated a transaction (e.g., via a smartphone or other computing device of the operator, via an interface of the power distributor 20) for a desired quantity of electrical power to be supplied to the operator's vehicle 1 via the EV charging system 10.

The robotic arm 50 of EV charging system 10 is positioned adjacent to the power distributor 20 in this exemplary embodiment. However, it may be understood that in some embodiments the robotic arm 50 may be distal the power distributor 20 which may vary in configuration from the power distributor 20 shown in FIG. 1. As will be discussed further herein, robotic arm 50 is configured to transport and manipulate the pose (e.g., the three-dimensional position and orientation) of the end effector 60 so that the end effector 60 may open an external cover 2 of the vehicle 1 covering an internal plug (not shown in FIG. 1) of the vehicle 1, remove or open the internal plug of the vehicle 1 to expose the vehicle charging connector (not shown in FIG. 1) of the vehicle 1, and electrically connect the distributor charging connector 22 of the EV charging system 10 with the exposed vehicle charging connector whereby electrical power may be communicated from the power distributor 20 of EV charging system 10 to the vehicle 1 (e.g., to charge the battery of vehicle 1).

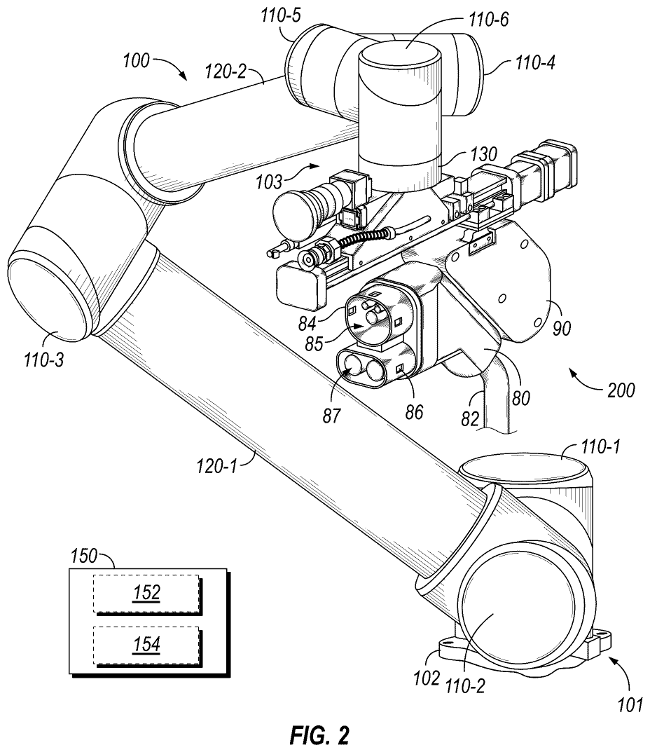

Referring now to FIG. 2, an embodiment of a robotic arm 100 and an end effector 200 coupled to the robotic arm 100 are shown. Robotic arm 100 and end effector 200 may comprise components of an automated EV charging system. For example, in some embodiments, the robotic arm 50 and end effector 60 shown in FIG. 1 are configured similarly as the robotic arm 100 and end effector 200 shown in FIG. 2; however, in other embodiments, robotic arm 50 and/or end effector 60 may vary in configuration from robotic arm 100 and end effector 200.

Robotic arm 100 provides end effector 200 with the degrees of freedom (DoFs) necessary to perform the functions required for charging an EV (e.g., opening an external cover of the EV, removing an internal plug of the EV). In this exemplary embodiment, robotic arm 100 extends between a first or proximal end 101 and a second or distal end 103 opposite the proximal end 101. In this exemplary embodiment, robotic arm 100 generally includes a base 102, a plurality of driven or actuatable joints 110 (e.g., joints selectably driven by one or more motors or actuators of the respective joint), a plurality of links 120 coupled between at least some of the plurality of joints 102 of robotic arm 100, and a tool carrier 130.

In this exemplary embodiment, base 102 forms the proximal end 101 of robotic arm 100 while the tool carrier 130 defines the distal end 103 of robotic arm 100. Base 102 attaches the robotic arm 100 to a corresponding support structure such as, for example, the ground, a track, a platform, etc. In some embodiments, the base 102 is attached to an underlying moveable support structure (e.g., a track, a carriage, a rotary table) that permits the robotic arm 100 to travel along the ground as needed and/or permits the robotic arm 100 to rotate relative to the ground. However, in other embodiments, the base 102 is coupled to a stationary support structure (e.g., a stationary platform, a foundation embedded into the ground) that fixes the location of robotic arm 100 relative to the ground.

The plurality of joints 110 (labeled as joints 110-1, 110-2, 110-3, 110-4, 110-5, and 110-6 in FIG. 2) are configured to transport or alter the pose of the end effector 200 coupled to the proximal end 103 of robotic arm 100 as controlled by a control system or controller 150. Each of the joints 110 comprises a powered or actuatable joint 110 including a motor or actuator (not shown in FIG. 2) for driving the motion of the given joint 110. Links 120 (labeled as links 120-1 and 120-2 in FIG. 2) are coupled between the joints 110 and increase the range of motion of the end effector 200. Particularly, end effector 200 is coupled to the tool carrier 130 located at the distal end of the robotic arm 100. In this exemplary embodiment, robotic arm 100 provides end effector 200 with six DoFs. However, it may be understood that in other embodiments robotic arm 100 may be configured differently than that shown in FIG. 2. For example, in other embodiments, robotic arm 100 may include fewer or additional joints 110 and/or links 120 than that shown in FIG. 2. Additionally, in other embodiments, robotic arm 100 may provide end effector 200 with fewer than the six DoFs provided by the embodiment illustrated in FIG. 2.

As described above, controller 150 controls the operation of the joints 110 of robotic arm 100 to thereby control the trajectory and pose of the end effector 200 coupled to the distal end 103 of robotic arm 100. Additionally, as will be described further herein, controller 150 controls the operation of the end effector 200. In some embodiments, controller 150 comprises a control system or controller of an EV charging system such as the EV charging system 10 shown in FIG. 1. Controller 150 is communicatively coupled to both the robotic arm 100 and the end effector 200. In this exemplary embodiment, controller 150 includes a processor 152 and a memory or non-transitory storage medium 154 communicatively coupled to the processor 152 and storing instructions executable by the processor 152 for controlling the operation of robotic arm 100 and end effector 200. The processor 152 may be implemented as one or more central processing unit (CPU) chips.

It is understood that by programming and/or loading executable instructions onto the controller 150, at least one of the processor 152 and memory device 154 are changed, transforming the controller 150 in part into a particular machine or apparatus having the novel functionality taught by the present disclosure. Additionally, the processor 152 may execute a computer program or application. For example, processor 152 may execute software or firmware stored in the memory device 154. During execution, an application may load instructions into processor 152, for example load some of the instructions of the application into a cache of processor 152. In some contexts, an application that is executed may be said to configure processor 152 to do something, e.g., to configure processor 152 to perform the function or functions promoted by the subject application. When processor 152 is configured in this way by the application, processor 152 becomes a specific purpose computer or a specific purpose machine.

Memory device 154 may be implemented as read only memory (ROM) and/or random-access memory (RAM). Memory device 154 may be referred to in some contexts as computer readable storage media and/or non-transitory computer readable media. Memory device 154 may be used to store instructions and perhaps data which are read during program execution.

As described above, end effector 200 is configured to facilitate the charging of an EV vehicle via an automated EV charging system (e.g., EV charging system 10 shown in FIG. 1) such that manual intervention (e.g., by an operator of the EV being charged) is not required. End effector 200 extends between a front 201 and a rear 203 opposite the front 201. In this exemplary embodiment, end effector 200 couples to an electrical distributor charging connector 80 of an EV charging system that is connected to an electrical cable 82 (shown partially in FIG. 2) of the EV charging system. Particularly, distributor charging connector 80 is releasably coupled to the end effector 200 by a connector holder 90 that is attached to the distributor charging connector 80. Additionally, distributor charging connector 80 comprises a pair of electrical pugs 84 and 86, each plug 84 and 86 comprising one or more corresponding electrical contacts (indicated by arrows 85 and 87, respectively). Distributor charging connector 80 may form an electrical connection with a corresponding vehicle charging connector of an EV by bringing the electrical contacts 85 and 87 of plugs 84 and 86, respectively, into electrical contact with corresponding electrical contacts of the EV. End effector 200, driven by robotic arm 100, facilitates the formation of this electrical connection between distributor charging connector 80 and the vehicle charging connector without the requirement of manual intervention.

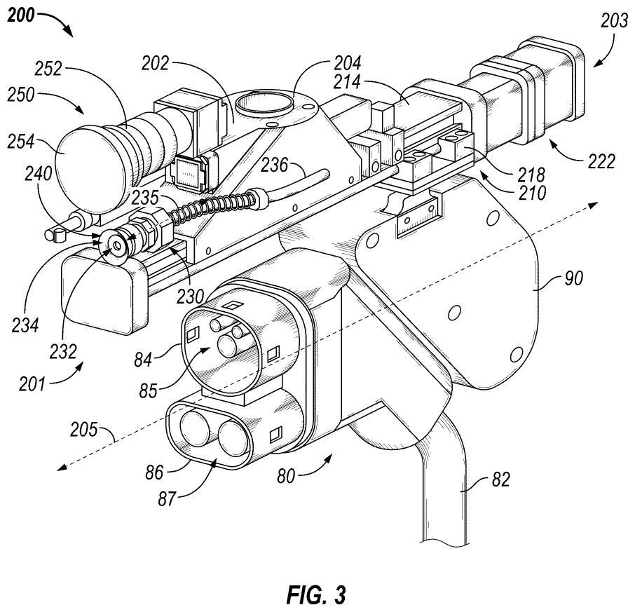

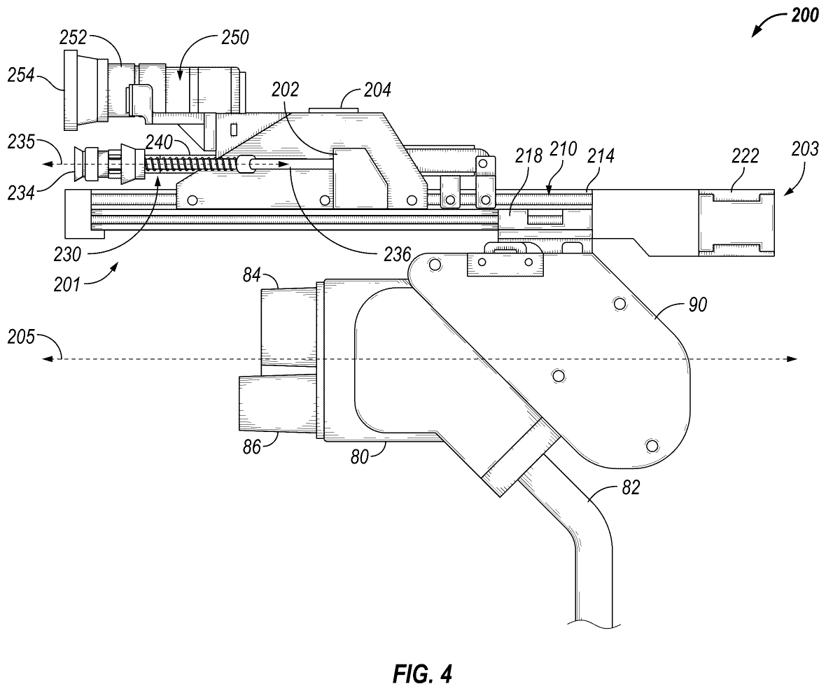

Referring to FIGS. 3 and 4, in this exemplary embodiment, end effector 200 generally includes a chassis 202, a support rail unit 210, a gripper unit 230, and a sensor unit 250. Chassis 202 provides structural support to the components (e.g., support rail unit 210, gripper unit 230, and sensor unit 250) of the end effector 200. Additionally, chassis 202 comprises a connector 204 for connecting the chassis 202 (and hence the end effector 200) to the distal end 103 of the robotic arm 100.

The support rail unit 210 of end effector 200 is carried by the chassis 202 and is generally configured to selectably transport the distributor charging connector 80 bi-directionally along a linear charger transport axis 205 defined by the support rail unit 210 and extending between the front 201 and the rear 203 of the end effector 200. Although charger transport axis 205 is shown as rectilinear in FIGS. 3 and 4, it maybe understood that in other embodiments charger transport axis 205 may be curved or otherwise not rectilinear. In this exemplary embodiment, support rail unit 210 generally includes an elongate or linear support rail 214, a carriage 218 slidably coupled to the support rail 214, and a carriage actuator 222 coupled between the support rail 214 and the carriage 218. Carriage 218 is coupled to the support rail 214 whereby carriage 214 is only permitted to travel linearly (and bi-directionally) along the support rail 214 in a direction that is parallel to the charger transport axis 205. In this exemplary embodiment, carriage 218 is also releasably coupled to the connector holder 90 attached to distributor charging connector 80 such that motion of the carriage 218 along the support rail 214 is transferred to the distributor charging connector 80 as motion along the charger transport axis 205.

In this exemplary embodiment, the carriage actuator 222 is coupled to an end of the support rail 214 and is additionally coupled to the carriage 218 for driving the motion of carriage 218 along the support rail 214. In some embodiments, the operation of carriage actuator 222 is controlled by the controller 150 shown in FIG. 2. In some embodiments, carriage actuator 222 comprises a stepper motor which allows for the carriage 218 to be transported bi-directionally and/or positioned along support rail 214 as commanded by the controller 150. For example, in certain embodiments, carriage actuator 222 comprises a stepper motor coupled to an elongate lead screw (not shown in FIGS. 3 and 4) which extends along the length of the support rail 214 and is coupled to the carriage 218. In this example, the stepper motor of carriage actuator 222 may selectably rotate the lead screw whereby the carriage 218 is transported linearly along the support rail 214. However, it may be understood that the configuration of carriage actuator 222 may vary in other embodiments.

The gripper unit 230 of end effector 200 is generally configured to open and close an external cover (e.g., external cover 2 shown in FIG. 1) of an EV, the external cover enclosing the vehicle charging connector of the EV. To state in other words, given that most EVs include an external cover to enclose their respective vehicle charging connector, the gripper unit 230 permits the end effector 200 to access the vehicle charging connector housed within the external cover such that the distributor charging connector 80 carried by end effector 200 may electrically connect to the corresponding vehicle charging connector.

In this exemplary embodiment, gripper unit 230 is carried or supported by the chassis 202 and generally includes a suction gripper 232, a vacuum or suction unit 236, and a gripper actuator 240. Suction gripper 232 is located along the front 201 of the end effector 200 and is supported by the chassis 202 of end effector 200. In this exemplary embodiment, suction gripper 232 is annular in shape an inner vacuum or suction chamber 234 located within the suction gripper 232. Suction chamber 234 is in fluid communication with the suction unit 236 of gripper unit 230 whereby the suction unit 236 may be activated to apply a vacuum within the suction chamber 234. In this exemplary embodiment, the suction unit 236 includes a pressure regulator, such as a pneumatic pressure regulator, for selectably applying a vacuum to the suction chamber 234 to facilitate the coupling of the suction gripper 232 to the external cover of an EV.

The gripper actuator 240 of gripper unit 230 is coupled between the chassis 202 and the suction gripper 232 and is generally configured to move or transport the suction gripper 232 relative to the chassis 202 during the operation of end effector 200. Particularly, in this exemplary embodiment, gripper actuator 240 comprises a linear actuator configured to transport suction gripper 232 bi-directionally along a gripper axis 235, where the gripper axis 235 may extend parallel to the charger transport axis 205. In this configuration, the suction gripper 232 may be moved along gripper axis 235 independently of the charger connector 80 which may, in some scenarios, be moved simultaneously along the charger transport axis 205. Additionally, in some embodiments, the operation of the suction unit 236 and the gripper actuator 240 of gripper unit 230 are controlled by the controller 150 shown in FIG. 2.

The sensor unit 250 of end effector 200 is communicatively coupled to the controller 150 and provides sensor feedback to the controller 150 when operating the robotic arm 100 and the end effector 200 (e.g., when operating the 222, the suction unit 136, the gripper actuator 240). The sensor data provided by the sensor unit 250 may be used by the controller 150 to determine, for example, the position of end effector 200 relative to the EV to be charged by an EV charging system comprising the robotic arm 100 and end effector 200. For example, the controller 150 may determine, based on sensor data provided by sensor unit 250, the position of suction gripper 232 relative to an external cover of the EV, and whether the external cover is open or closed. As another example, the controller 150 may determine, based on sensor data provided by sensor unit 250, the position of distributor charging connector 80 relative to a corresponding vehicle charging connector of the EV so that controller 150 may electrically connect the charging connector 80 to the corresponding vehicle charging connector.

In this exemplary embodiment, sensor unit 250 is coupled or mounted onto the chassis 202 of end effector 200 and comprises a camera 252 having a lens 254 located at the front 201 of end effector 200. In this configuration, a field of view (FoV) of the lens 254 projects from the front 201 of the end effector 200 thereby positioning whatever is located in front of the end effector 200 into the FoV of the camera 252. Thus, by positioning the external cover of the EV in front of the camera 252, the camera 252 may capture images (provided to the controller 150 as sensor or image sensor data) of the external cover, and of the vehicle charging connector once the external cover has been opened by the gripper unit 230 of end effector 200. In this manner, the images captured by cameras 252 may be utilized as sensor data by the controller 150 for controlling the operation of the robotic arm 100 and end effector 200. In some embodiments, the controller 150 executes a computer vision application for automatically identifying objects (e.g., an EV, an external cover of the EV, an internal charging plug of the EV, a vehicle charging connector of the EV) captured in the images taken by camera 252. In some applications, the computer vision application may comprise a machine learning (ML) algorithm previously trained using a training dataset including, for example, images of the various objects to be identified by the controller 150 from the image data provided thereto by the camera 252.

It may be understood that the configuration of sensor unit 250 may vary in other embodiments. For example, in some embodiments, sensor unit 250 may include sensors in addition to the camera 252 for providing sensor data to the controller 150. In still other embodiments, sensor unit 250 may not include camera 252 or any other camera and instead may rely on other sensors for providing controller 150 with sensor data sufficient to permit controller 150 to operate the robotic arm 100 and end effector 200 to automatically charge an EV positioned proximal the robotic arm 100. As an example, in some embodiments, sensor unit 250 may comprise at least one of a time of flight (ToF) sensor, a mono camera, stereo cameras, and a light detection and ranging (LIDAR) sensor.

Referring generally to FIGS. 2-4, having described various structural features of the robotic arm 100 and end effector 200, an exemplary embodiment for the operation of robotic arm 100 and end effector 200 (as directed automatically by controller 150) will now be described. In some embodiments, once the operator of an EV has positioned their EV proximal an automated EV charging system comprising the robotic arm 100 and end effector 200, and has initiated a transaction for charging the EV via the EV charging system, the controller 150 operates the robotic arm 100 to deploy the end effector 200 such that the end effector 200 is positioned directly in front of the external cover of the EV (e.g., external cover 2 of the EV 1 shown in FIG. 1). To state in other words, the controller 150 may initially deploy the end effector 200 from a setback or rest position spaced from the EV to an operating position with the front 201 of end effector 200 positioned adjacent the external cover of the EV. The controller 150 utilizes sensor data provided by sensor unit 150 (potentially along with other sensor data provided to controller 150 by the EV charging system) to guide the end effector 200 from the setback position to the operating position. For example, the controller 150 may identify the external cover in the images captured by the camera 232 of camera unit 230 to thereby position the front 201 of the end effector 200 adjacent the external cover.

With the front 201 of end effector 200 located proximal the external cover the respective EV, the controller 150 automatically operates the gripper unit 230 to transition the external cover from its normally closed position to an open position providing access to the vehicle charging connector located behind the external cover. Particularly, in this exemplary embodiment, the controller 150 automatically operates the gripper actuator 240 of gripper unit 230 to extend the suction gripper 232 along gripper axis 235 and away from the chassis 202 of end effector 200 and towards the external cover of the EV until the suction gripper 232 makes sealing contact with the external cover. Following the formation of sealing contact between the suction gripper 232 of gripper unit 230 and the external cover of the EV, the controller 150 automatically operates the suction unit 236 of gripper unit 230 to apply a vacuum to the now sealed suction chamber 234 positioned within the suction gripper 232. For example, the controller 150 may activate a pneumatic pump or other device to pump air from the suction chamber 234 to thereby apply a vacuum to the suction chamber 234.

The formation of a vacuum in the suction chamber 234 couples or attaches the suction gripper 232 to the external cover such that the suction gripper 232 may apply an opening force to the external cover to open the cover. Specifically, in this exemplary embodiment, controller 150 operates the gripper actuator 240 to retract the suction gripper 232 along gripper axis 235 and towards the chassis 202 of end effector 200 whereby an opening force is applied to the external cover by the suction gripper 232 to open the external cover such that the external cover occupies an open position. With the external cover in the open position, the controller 150 automatically operates the suction unit 236 to release the vacuum from suction chamber 234 to thereby physically release the suction gripper 232 from the external cover of the EV. In some embodiments, controller 150 utilizes sensor data (e.g., sensor image data) provided by sensor unit 250 in determining that the external cover has been successfully transitioned from the closed position to the open position by gripper unit 230.

Following the opening of the external cover of the EV, controller 150 automatically operates the carriage actuator 222 of support rail unit 210 to transport the distributor charging connector 80 along the charger transport axis 205 towards the front 201 of end effector 200 whereby the plugs 84 and 86 of distributor charging connector 80 may couple with corresponding plugs of the EV previously hidden behind the external cover thereof. In this manner, the electrical contacts 85 and 87 of plugs 84 and 86, respectively, enter into contact with corresponding electrical contacts of a corresponding vehicle charging connector whereby an electrical connection is formed between distributor charging connector 80 and the vehicle charging connector. In this manner, electrical power may be delivered from the distributor charging connector 80 to the vehicle charging connector across the electrical connection formed therebetween to the charge the battery of the EV (electrically connected to the vehicle charging connector).

In this exemplary embodiment, once the desired amount of electrical power has been delivered to the EV (e.g., as initially prescribed by the operator of the EV when initiating the transaction with the EV charging system), controller 150 automatically retracts distributor charging connector 80 along charger transport axis 205 towards the rear 203 of end effector 200 whereby the distributor charging connector 80 is electrically disconnected from the corresponding vehicle charging connector. Additionally, following the disconnection of distributor charging connector 80 from the vehicle charging connector, controller 150 automatically operates the gripper unit 230 of end effector 200 to restore the external cover of the EV to its normally closed position enclosing the vehicle charging connector. The controller 150, following the closing of the external cover of the EV, may also automatically operate the robotic arm 100 to return the end effector 200 to its setback position providing the operator of the EV with sufficient space to depart from the EV charging system with a freshly charged battery.

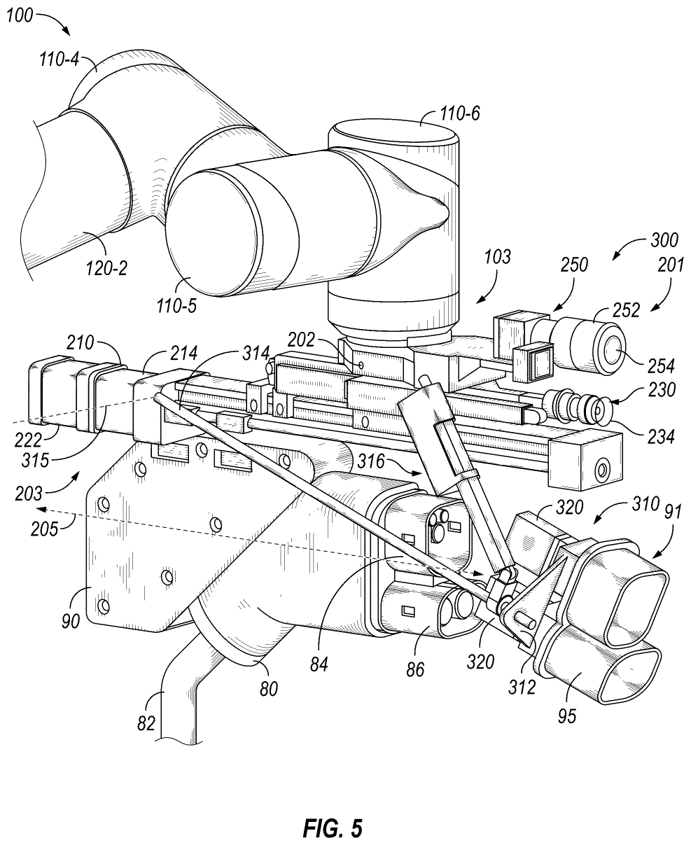

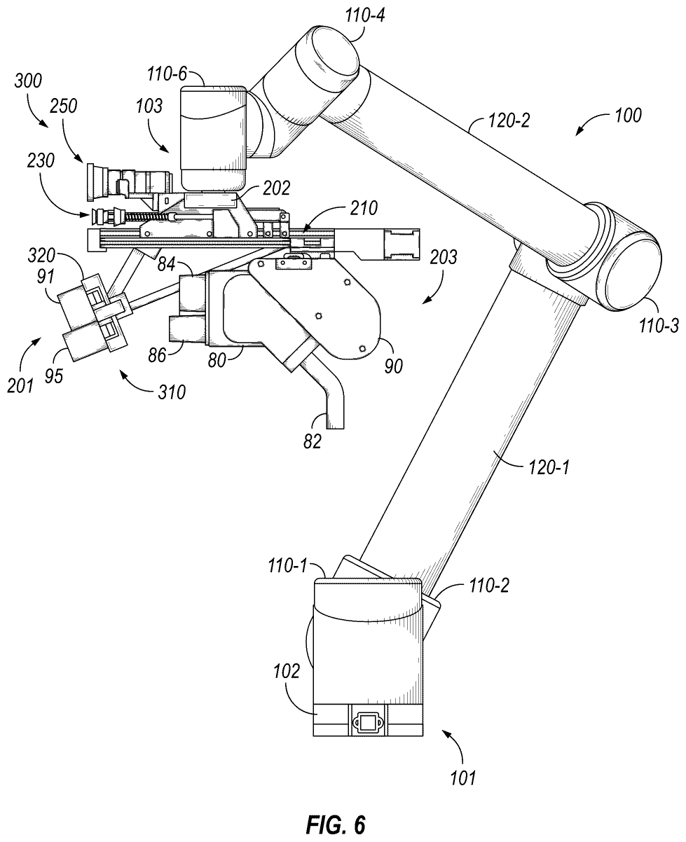

Referring now to FIGS. 5-8, another embodiment of an end effector 300. In some embodiments, end effector 300 comprises a component of an automated EV charging system. For example, in certain embodiments, the end effector 60 shown in FIG. 1 is configured similarly as the end effector 300 shown in FIGS. 5-8; however, in other embodiments, end effector 60 may vary in configuration from that of end effector 300. Additionally, the embodiment of end effector 300 shown in FIGS. 5 and 6 shares features in common with end effector 200 shown in FIGS. 2-4, and shared features are labeled similarly. Further, in some embodiments, end effector 300 may be carried by and coupled to the distal end 103 of robotic arm 100 or other robotic arms varying in configuration from robotic arm 100.

In this exemplary embodiment, end effector 300 is similar to end effector 200 except that end effector 300 additionally includes a plug handler unit 310 for removing internal plugs of an EV. Particularly, in some instances, the one or more vehicle charging connectors of an EV (positioned behind the closed external cover) are protected by one or more corresponding charger plugs that are enclosed by the external cover of the EV. The internal plugs may protect electrical contacts of the one or more vehicle charging connectors from the external environment, such as rain and other external conditions. Additionally, the internal plugs may prevent an operator of the EV from accidently contacting the electrical contacts of the one or more vehicle charging connectors with an electrically conductive object which could otherwise potentially short the vehicle charging connectors and thereby damage the EV and potentially injure the operator.

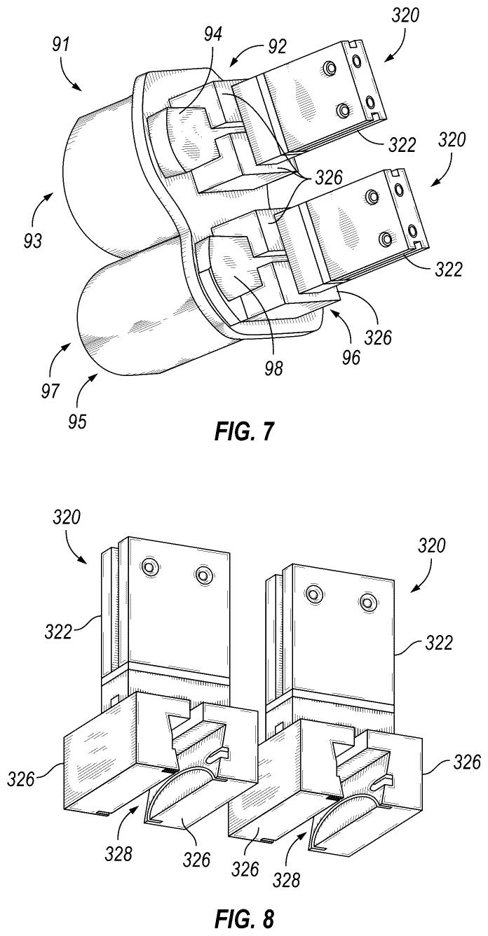

As an example, a pair of exemplary internal plugs 91 and 95 of an EV are shown in FIGS. 5-7. Internal plugs 91 and 95 are shown in isolation (e.g., isolated from the EV to which they belong) in FIGS. 5-7 in the interests of clarity and convenience, but it may be understood that in at least some embodiments internal plugs 91 and 95 may be physically attached to the EV to which they belong. As shown particularly in FIG. 7, a first internal plug 91 of the pair of plugs 91 and 95 has an enclosed end 92, an open end 93 opposite the enclosed end 92, and a handle 94 located at the enclosed end 92. Similarly, a second internal plug 95 of the pair of plugs 91 and 95 has an enclosed end 96, an open end 97 opposite the enclosed end 96, and a handle 98 located at the enclosed end 96. A pair of corresponding vehicle charging connectors of the EV are receivable in the open ends 93 and 97 of the pair of plugs 91 and 95 to thereby protect the vehicle charging connectors from the external environment. Additionally, the handles 94 and 98 of plugs 91 and 95 are configured to be manually grasped by an operator of the EV such that the operator may remove or decouple plugs 91 and 95 from the corresponding vehicle charging connectors.

In this exemplary embodiment, plug handler unit 310 of end effector 300 generally includes a handler chassis 312, and a pair of plug handlers 320 coupled or mounted to the handler chassis 302. Additionally, plug handler unit 310 includes a pivot link 314 and a handler actuator 316 each coupled to the chassis 302. Particularly, pivot link 314 is pivotably coupled between the support rail 204 of support rail unit 202 and the chassis 302 whereby chassis 302 is permitted to rotate about a handler rotation axis 315 which extends generally perpendicular to the charger transport axis 205. In this exemplary embodiment, handler actuator 316 comprises a linear actuator configured to selectably rotate or position the chassis 312 about the handler rotation axis 315. For example, in some embodiments, the handler actuator 316 is communicatively coupled to the controller 150 shown in FIG. 2 whereby the controller 150 may automatically control the operation of handler actuator 316. Particularly, the controller 150 may operate handler actuator 316 to rotate chassis 312 between a standby position (not shown) in which the chassis 312 is arcuately offset from the charger transport axis 205 and an operating position (shown in FIGS. 5 and 6) in which the chassis 312 is positioned generally along the charger transport axis 205 such that the chassis 312 occupies a position located between the charger 80 and vehicle charging connector(s) of the EV to be charged using the end effector 300.

While in this exemplary embodiment the plug handler unit 310 includes a pair of plug handlers 320, the number of plug handlers 320 may vary in other embodiments from a single plug handler 320 to more than two plug handlers 320. The pair of plug handlers 320 in this exemplary embodiment are generally configured to selectably grasp the corresponding plugs 91 and 95 of the EV to be charged by distributor charging connector 80 such that plug handler unit 310 may successfully remove internal plugs 91 and 95 from their normally closed positions enclosing the corresponding vehicle charging connectors of the EV, to an open position providing access to the vehicle charging connectors (e.g., whereby distributor charging connector 80 may electrically connect to the vehicle charging connectors). As shown particularly in FIG. 8, in this exemplary embodiment, the pair of plug handlers 320 each comprise a base in the form of a gripper actuator 322, and a pair of opposed fingers or grippers 326 each defining an opening 328 extending therebetween.

The gripper actuators 322 of plug handlers 320 are coupled to and carried by the chassis 312 such that plug handlers 320 travel in concert with the chassis 312 of plug handler unit 310. Additionally, in this exemplary embodiment, gripper actuators 322 comprise internally ported pneumatic actuators that are fluidically connected to a pneumatic system of the end effector 300 for selectably pressurizing and depressurizing the gripper actuators 322. For example, in some embodiments, gripper actuators 322 are powered by components (e.g., a pressure regulator, a pump, a compressor) of the suction unit 236 of gripper unit 230. Although gripper actuators 322 comprise pneumatic actuators in this exemplary embodiment powered via pneumatic pressure, it may be understood that gripper actuators 322 may vary in configuration in other embodiments. For example, in other embodiments, gripper actuators 322 may comprise hydraulic actuators, electromechanical actuators (e.g., solenoids), and the like.

By modulating the pneumatic pressure supplied to the gripper actuator 322 of a respective plug handler 320, the grippers 326 of the plug handler 320 may be actuated to increase or decrease the width of the respective opening 328 formed between the pair of grippers 326. For example, by pressurizing the gripper actuator 322 (e.g., as controlled by controller 150) of the respective plug handler 320, the pair of grippers 326 may be squeezed together to reduce the width of the opening 328 formed therebetween. The squeezing together of grippers 326 may be utilized to grasp the handle 94/98 of a corresponding internal plug 91/95, respectively, with the grippers 326 contacting and squeezing against the respective handle 94/98 received in the opening 328 formed between the pair of grippers 326. Conversely, by depressurizing the gripper actuator 322 of the respective plug handler 320, the pneumatic force squeezing together the pair of grippers 326 of the plug handler 320 may be released, permitting the width of the opening 328 formed therebetween to expand. In this manner, a handle 94/98 of an internal plug 91/95 grasped by the pair of grippers may be released from the respective plug handler 320 by depressurizing (e.g., via venting or another mechanism) the pneumatic pressure previously contained in the gripper actuator 322 of the plug handler 320.

Referring still to FIGS. 5-8, having described various structural features of the end effector 300, an exemplary embodiment for the operation of end effector 300 (as directed automatically by controller 150) will now be described. Particularly, in some embodiments, the operation of end effector 300 is similar to the operation of end effector 200 described above except for respect to the operation of plug handler unit 310 which is missing from the end effector 200.

For example, following the opening of the external cover of the EV by gripper unit 230, the plug handler unit 310 is operated by the controller 150 to remove the internal plugs 91 and 95 of the EV (in this example) previously enclosed by the external cover. Specifically, the controller 150 operates the handler actuator 316 to rotate the chassis 312 of plug handler unit 310 about rotation axis 315 from the standby position to the operating position shown in FIGS. 5 and 6. With plug handler unit 310 in the operating position, controller 150 extends the pair of plug grippers 320 towards the enclosed ends 92 and 96 of the pair of internal plugs 91 and 95, respectively, of the EV until the handles 94 and 98 of the internal plugs 91 and 95 are received in the openings 328 of the pair of plug grippers 320. For example, controller 150 may operate robotic arm 100 to displace the pair of plug grippers 320 towards the corresponding pair of internal plugs 91 and 95 until the handles 94 and 98 thereof are received in the openings 328 of plug grippers 320.

In this exemplary embodiment, with the handles 94 and 98 of internal plugs 91 and 95, respectively, received in the openings 328 of plug grippers 320, controller 150 operates the gripper actuators 322 of plug grippers 320 to squeeze the pair of grippers 326 of the plug grippers 320 against the corresponding handles 94 and 98 of internal plugs 91 and 95 to couple or secure the internal plugs 91 and 95 to the pair of plug grippers 320. In this configuration, controller 150 retracts the plug handler unit 310 from the vehicle charging connectors to thereby release the internal plugs 91 from the corresponding charging connectors to expose the charging connectors of the EV to the external environment. For example, controller 150 may manipulate robotic arm 100 to retract the plug handler unit 310 from the EV whereby the pair of grippers 326 of the plug grippers 320 may separate or remove the pair of internal plugs 91 and 95 from the corresponding charging connectors of the EV. The controller 150 may additionally manipulate the robotic arm 100 to operate the plug handler unit 310 to reinstall the pair of internal plugs 91 and 95 once the EV has been charged by the EV charging system.

While exemplary embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

What is claimed is:

1. An end effector for an automated electric vehicle (EV) charging system, the end effector comprising:
a chassis comprising a chassis connector for coupling the end effector to an end of a robotic arm; and
a support rail unit coupled to the chassis and comprising an elongate support rail, a carriage slidably coupled to the support rail and comprising a carriage connector configured to couple to an electric distributor charging connector of the EV charging system, and a carriage actuator coupled between the support rail and the carriage for transporting the carriage along the support rail.

2. The end effector of claim 1, wherein the carriage is configured to transport the distributor charging connector along a linear charger transport axis in response to the activation of the carriage actuator when the distributor charging connector is coupled to the carriage.

3. The end effector of claim 1, further comprising a gripper unit coupled to the chassis and configured to open an external cover of the EV enclosing a vehicle charging connector of the EV.

4. The end effector of claim 3, wherein the gripper unit comprises a suction gripper and a suction unit each coupled to the chassis, wherein the suction unit is configured to apply a vacuum to a suction chamber defined by the suction gripper to releasably couple the suction gripper to the external cover.

5. The end effector of claim 4, wherein the gripper unit further comprises a gripper actuator configured to displace the suction gripper relative to the chassis along a gripper axis.

6. The end effector of claim 1, further comprising:
a controller communicatively coupled to the carriage actuator; and
a sensor unit coupled to the chassis and configured to provide the controller with sensor data as the controller controls the operation of the carriage actuator.

7. The end effector of claim 6, wherein the sensor unit comprises a camera having a field of view projecting from a front of the end effector.

8. The end effector of claim 1, further comprising a plug handler unit coupled to the chassis, the plug handler unit comprising an actuatable plug handler for gripping an internal plug of a vehicle charging connector of an EV.

9. The end effector of claim 8, wherein the plug handler comprises a gripper actuator and a pair of grippers coupled to the gripper actuator, the gripper actuator configured to displace the pair of grippers to increase and decrease a width of an opening formed between the pair of grippers.

10. The end effector of claim 8, wherein the plug handler unit comprises a handler actuator configured to pivot the plug handler relative to the support rail unit between a standby position and an operating position spaced from the standby position.

11. An automated electric vehicle (EV) charging system, comprising:
a power distributor for distributing electrical power to one or more EVs;
an electric distributor charging connector connected to the power distributor by an electrical cable;
a robotic arm extending between a proximal end and a distal end opposite the proximal end, the robotic arm comprising one or more actuatable joints;
an end effector coupled to the distal end of the robotic arm, wherein the distributor charging connector is coupled to and carried by the end effector; and
a controller communicatively coupled to the robotic arm and the end effector, the controller configured to manipulate the robotic arm and the end effector to electrically connect the distributor charging connector to a vehicle charging connector of an EV whereby electrical power is transmittable from the power distributor to the EV.

12. The EV charging system of claim 11, wherein the end effector comprises:
a chassis comprising a chassis connector coupled to the distal end of the robotic arm; and
a support rail unit coupled to the chassis an comprising an elongate support rail, a carriage slidably coupled to the support rail and comprising a carriage connector configured to couple to an electric distributor charging connector of the EV charging system, and a carriage actuator coupled between the support rail and the carriage for transporting the carriage along the support rail.

13. The EV charging system of claim 12, wherein the controller is communicatively coupled to the carriage actuator and configured to operate the carriage actuator to transport the distributor charging connector along a linear charger transport axis to establish an electrical connection between the distributor charging connector and the vehicle charging connector.

14. The EV charging system of claim 11, wherein the end effector comprises a chassis and a gripper unit coupled to the chassis, the gripper unit comprising a suction gripper operable by the controller to open an external cover of the EV enclosing the vehicle charging connector.

15. The EV charging system of claim 11, wherein the end effector comprises a sensor unit communicatively coupled to the controller, the sensor unit comprising a camera configured to provide the controller with image data captured by the camera.

16. The EV charging system of claim 11, wherein the end effector comprises a chassis and a plug handler unit coupled to the chassis, the plug handler unit comprising an actuatable plug handler operable by the controller for gripping an internal plug of a vehicle charging connector of an EV.

17. The EV charging system of claim 16, wherein the plug handler unit comprises a handler actuator communicatively coupled to the controller, the controller configured to operate the handler actuator to pivot the plug handler between a standby position and an operating position spaced from the standby position.

18. A method for charging an electric vehicle (EV) using an automated EV charging system, the method comprising:
(a) manipulating an end effector of the EV charging system that is coupled to a robotic arm of the EV charging system to open an external cover of an EV enclosing a vehicle charging connector of the EV;
(b) manipulating the end effector to electrically connect a distributor charging connector of the EV charging system to the vehicle charging connector to transmit electrical power from a power distributor of the EV charging system to the EV; and
(c) manipulating the end effector to close the external cover of the EV to enclose the vehicle charging connector.

19. The method of claim 18, wherein (a) comprises:
(a1) manipulating a suction gripper of the end effector to form a releasable connection between the suction gripper and the external cover; and
(a2) manipulating the suction gripper to release the connection formed between the suction gripper and the external cover once the external cover has been opened by the end effector.

20. The method of claim 18, wherein (b) comprises:
(b1) manipulating the end effector to transport the distributor charging connector in a first direction along a charger transport axis to electrically connect the distributor charging connector to the vehicle charging connector; and
(b2) manipulating the end effector to transport the distributor charging connector in a second direction, opposite the first direction, along the charger transport axis to electrically disconnect the distributor charging connector from the vehicle charging connector.
